(19) United States
(12) Patent Application Publication
(10) Pub. No.: US 2011/0076996 A1
(43) Pub. Date: Mar. 31, 2011

(54) Automatic short messaging system and/or call suspension for wireless devices in motion

(76) Inventors: Victor C. Burton, Bellevue, WA (US); Mark J. Ramberg, Annapolis, MD (US)

(21) Appl. No.: 12/923,544

(22) Filed: Sep. 28, 2010

Related U.S. Application Data
(60) Provisional application No. 61/272,473, filed on Sep. 28, 2009.

(51) Int. Cl. H04W 4/12

(52) U.S. Cl. 455/418

(57) ABSTRACT

Automatic suspension of call and/or short text message service for a mobile device in motion. The speed of the wireless device is obtained or detected, and compared with a predetermined speed threshold to determine whether the speed has reached or exceeded the predetermined speed threshold. If so, suspension of a text messaging service is automatically triggered in response to the speed exceeding or reaching the threshold. Emergency call and/or text messaging capabilities may be retained even during suspension of service. An indication of the service suspension may be displayed on the mobile device. Suspension of the relevant service may be maintained for a predetermined period of time to provide a hysteresis so that when the device momentarily stops but is generally still in a driven situation, the service(s) remain suspended. The wireless device may permit a user to temporarily disable the suspension of service for a given period of time.

The present application claims priority from U.S. Provisional No. 61/272,473, filed Sept. 28, 2009, entitled “Automatic SMS and/or Call Suspension System and Method for Mobile Devices in Motion,” to Burton et al., the entirety of which is explicitly incorporated herein by reference.

### BACKGROUND OF THE INVENTION

1. Field of the Invention

This invention relates to wireless communications, but more specifically to an automatic call and/or short messaging system (SMS) or other text message suspension system for a wireless device in motion.

2. Background of the Related Art

Advances in communication technology often bring unwanted problems. Our society has recently recognized the potential for dangerous situations in transportation and vehicle mobility with the use of texting and calling features of wireless devices. Texting and for that matter conversing on a wireless phone (hands-on) while driving can be dangerous and has been attributed to distractions that have caused countless accidents. In many states it is now illegal to use a hands-on cell phone or other communication device while driving or operating a moving vehicle; nevertheless, there are those that continue to do so. In 2009, it was estimated in one study that as many as 45% of drivers nationwide under 30 years old text message, e.g., send a short messaging system (SMS) text message, while driving. It also came to light that a train operator, responsible for the worst train accident in 15 years, was texting immediately before the accident occurred, leading to the inference that distractions associated with text messaging may have contributed significantly to the cause of that accident.

A Safe Driving System in Utah has addressed this problem with a device that plugs into an onboard diagnostic port of a vehicle and sends a local wireless suspension signal to a nearby cell phone when the vehicle starts. The suspension signal triggers the cell phone to suspend service for all incoming and outgoing SMS and voice calls, with the exception of 911 calls. However, the present inventors have realized that this device has a significant drawback in that it relies on the presumption that the driver will plug the device into the vehicle's onboard diagnostic port in the first place. Ultimately control of this device is given to the driver, who can disable its operation at any time by merely unplugging it from the onboard diagnostic port (intentionally or unintentionally). Furthermore, such a local solution is limited to use only in vehicles that provide an onboard diagnostic port: a feature that many if not most vehicles lack.

### SUMMARY OF THE INVENTION

In accordance with the principles of the present invention, a method of automatically triggering suspension of a text messaging service on a wireless device while in a driven vehicle comprises obtaining a speed of a wireless device capable of a text messaging service. It is determined if the speed exceeds a predetermined threshold speed. If the speed exceeds the predetermined threshold speed, suspension of the text messaging service is automatically triggered.

In accordance with another aspect of the invention, a wireless device providing automatic suspension of a text messaging service when in a driven vehicle comprises a speed detection module to obtain a speed of a wireless device capable of a text messaging service. A threshold detector determines if the obtained speed exceeds a predetermined threshold speed. A suspension triggering module automatically triggers suspension of the text messaging service if the speed exceeds the predetermined threshold speed.

### BRIEF DESCRIPTION OF THE DRAWINGS

Features and advantages of the present invention will become apparent to those skilled in the art from the following description with reference to the drawings:

FIG. 1 shows a mobile wireless device in communication with a wireless network in accordance with a first aspect of the present invention.

FIG. 2 shows a method of automatic call/text message suspension for a wireless device in motion in accordance with another aspect of the present invention.

### DETAILED DESCRIPTION OF ILLUSTRATIVE EMBODIMENTS

The invention comprises a system and method to provide autonomous detection and triggering of suspension relating to certain services based on a velocity of the wireless device. A suspension signal application module executed on a wireless device detects the velocity of that wireless device and causes automatic suspension of SMS and voice services while that wireless device is in motion. An appropriate suspension signal may be generated by the relevant wireless device itself and sent back to their service provider via the wireless network upon detection in excess of a given velocity of the wireless device. Thus, upon detection of the given velocity of the wireless device, functional operation of short messaging system (SMS), MMS, and/or other text messaging services are suspended as long as the wireless device continues to be presumed to be accessible to a driver in a driven vehicle.

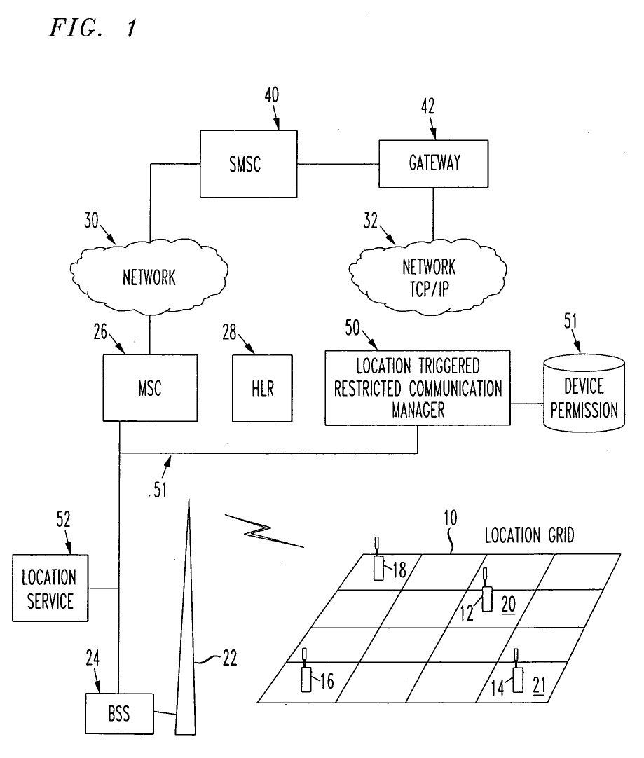

FIG. 1 shows a wireless network with which the invention may be implemented.

In particular, as shown in FIG. 1, in customary operation, a wireless device 10 conveys voice and/or text messages with other devices in communication with network 20. Suitable wireless devices include, for example, cell phones, VoIP phones, PDAs, laptops, etc.

The servicing wireless network 20 may include one or more communication towers 22 and associated equipment serving a region in which the wireless device 10 is operated. In a conventional wireless network, a base station system 24 couples a communication tower 22 to convey subscriber signals to and from a mobile switching center (MSC) 26. Appropriate subscriber information is contained in a home location register 28. Although only one MSC 26 is shown, multiple mobile switching centers (MSCs) handling other wireless devices may intercommunicate through an appropriate network (e.g., a SS7 network) 30.

Links interconnecting the functional elements of FIG. 1 are symbolic of standard communication protocols implemented in the industry. For example, communication between base station system 24 and the mobile switching center 26 may proceed under SS7 protocols while communication between the SMSC 40 and the network 32 may proceed under a TCP/IP protocol.

Subscriber calls may be routed to a remote device (not shown) (e.g., another cell phone) in communication with a remote mobile switching center through an SS7 network 30. In addition, the network may include a short message service center 40 to convey SMS messages between and among wireless devices. Multiple SMSCs may intercommunicate with each other through a gateway 42 via a TCP/IP network 32, as is known in the art.

TCP/IP-based subscribers access the TCP/IP network 32 via the gateway 34. The wireless network 20 may also include a location service platform 52 to detect the location of a wireless device 10 within the service area of the communication tower 22.

Velocity of the wireless device may be detected in any suitable manner, e.g., based on a time-based difference in position as determined by a local or remote location service.

Ideally the velocity at which suspension is caused may be that which is typically associated with driving. As an example, a velocity greater than 5 mph may be presumed to be associated with driving.

In accordance with the principles of the present invention, the need for suspension of text and voice services may be qualified against a location of the relevant wireless device. For instance, if the wireless device is currently located on a street, and is moving at a speed determined to be associated with driving along that street (e.g., greater than 5 mph), then suspension is ordered. On the other hand, if the wireless device is moving greater than a given velocity (e.g., greater than 5 mph) yet is not on a known street (which would ordinarily be required for driving), then transmission of the suspension signal may be voided until a time at which the wireless device becomes located on a mapped street. This would permit use of voice and text services when riding in a train, ferry, boat, plane, etc. Travel along a mapped street may additionally be sensed as an additional qualifier to cause generation of the suspension signal.

Suspension of SMS or other text messaging services may be affected by causing the text messaging program to close and/or not allowing the text messaging program to open. Alternatively, suspension may merely affect desired functions required to text, e.g., suspension may be accomplished by disabling alpha character entry into the wireless device, and/or disabling the text display screen, etc.

Network-based location-based services may employ time-of-arrival measurements, signal strength measurements, and/or other methods known in the art. The location of the wireless device 10 may also be obtained by a subscriber-based GPS or accelerometer chip installed in the wireless device 10.

According to an aspect of the present invention, the speed or movement of the wireless device 10 along a path 18 over the surface of the earth is detected or calculated by an application module 14 executed in the wireless device 10 to trigger suspension of voice and SMS or other text messaging when the velocity (speed) or other detected movement presuming to be associated with driving in a vehicle exceeds a predetermined speed threshold.

In one embodiment, the application module 14 periodically or intermittently samples GPS coordinates produced by a GPS chip 12. Using an internal clock, the application module 14 then uses a change in the relevant GPS coordinates to determine a current velocity of the wireless device 10 based on a distance traveled per unit time (presumed to be linear between the two GPS locations).

In another embodiment, the application module 14 obtains or determines a velocity indication from an accelerometer chip 12 carried in the wireless device 10. An accelerometer chip may be configured to directly provide a velocity indication or otherwise provide additive or/subtractive force indications from which velocity may be derived. Once the velocity of the wireless device 10 is ascertained by the application module 14, the need for suspension of voice and SMS and other text messaging services may be determined, along with other factors.

In yet another alternative embodiment, velocity of a given wireless device may be detected by a wireless network providing service to the moving wireless device. In this embodiment, in response to detection of probable involvement of the wireless device in a driven vehicle, a suspension command signal is sent to the relevant wireless device from the wireless network to affect suspension of voice and/or SMS, MMS, and/or other text messaging services.

Upon determination of movement of the given wireless device beyond a given threshold velocity level, the relevant wireless device is suspended from operable service of voice and SMS and other text messaging. As an example, if velocity of the wireless device is determined to be, e.g., a speed of “x” meters per second that distinguishes between, a user's walking speed and a typical vehicle speed when the device is operated in a vehicle, service to that wireless device is temporarily suspended.

Suspension may be for a predetermined period of time, e.g., for 1 minute, until a fresh determination of the velocity is obtained to determine if voice and SMS service may be once again resumed for that wireless device.

In the alternative embodiment where velocity of the wireless device is determined by a wireless network element other than the wireless device itself, suspension of voice and SMS and other text messaging services may be resumed as soon as the velocity is measured to be within an acceptable velocity.

An indication of the temporary suspension of voice and SMS services may be provided to the user via an appropriate indication on the display 16 of the wireless device 10. In yet another embodiment, once suspension of voice and SMS or other text messaging services is initiated, the user may be required to manually request resumption of voice and text messaging services by selection of an appropriate menu choice on the relevant wireless device 10.

The application module 14 may of course always retain the ability to permit the user to make any emergency call despite (in fact even during) suspension of voice and SMS or other text messaging services. In this way emergency calls and messages may proceed normally and unobstructed.

In situations where the wireless device 10 lacks an accelerometer, GPS or other chip capable of permitting an accurate determination of current velocity, suspension of voice and SMS or other text messaging services may alternatively be affected with the aid of the wireless network 20 based on a velocity presumed associated with driving from an appropriate location service or other platform 52. In that case, velocity is determined based on changes in device location as detected by the operator's network. After such device velocity is determined, the wireless network 20 may affect suspension of certain features (e.g., voice and/or SMS, MMS, etc.) by, for example, use of an application executed in the MSC 26 to trigger suspension of voice and text messaging features once the velocity of the wireless device 10 reaches or exceeds a predetermined threshold. Alternatively, the application module 14 may obtain time-based position information over the wireless network from an appropriate location service platform 52 from which to determine velocity and consequent instructions to suspend voice and SMS or other text messaging features.

Suspension of voice and SMS or other text messaging features as described herein relates not to the suspension of such services from a wireless network, but rather to specific features which will prevent the user of a given wireless device from being distracted by use of such services. The specific features for any given wireless device may differ from device to device.

An example of specific features that are disabled in an exemplary wireless device when suspended from voice and SMS or other text messaging features due to a presumption of driving include: automatic closing of the relevant feature on the relevant wireless phone (e.g., forced closure of the email application, forced closure of the SMS or other text messaging program); prevention of use of a keyboard; prevention of display altogether; prevention of display of features determined to be distracting (such as email, SMS, etc.), etc.

The invention is implemented by an application module 14 executed on the wireless handset 10 that may use a GPS chip in the handset to calculate velocity of the device at certain time intervals, e.g., every few seconds more or less. For devices moving faster than a certain threshold (e.g., faster than a walking of jogging speed), application module 14 automatically suspends SMS and/or voice services except for emergency 9-1-1 calls. Once the application module detects that the device's velocity exceeded the threshold, it may reduce the time interval between velocity calculation updates. For example, initial calculations may be performed every minute or fraction thereof but once the movement of device 10 exceeds the threshold, the application module 14 may perform calculation every five seconds, more or less.

When the application module 14 suspends SMS and/or voice calls, it may also produce a display of an appropriate graphic or message on display 16 of the wireless device 10 indicating that SMS and/or voice service has been temporarily suspended without an audible alert, as desired.

In cases where movement of device 10 momentarily stops for a stop light, traffic jam, or other reasons, for example, application module 14 may maintain suspension, e.g., up to 5 minutes thereafter to allow for temporary storage before automatically turning the suspended service back on to thereby reinstate call and message services. This buffer period enables confirmation that the device is, in fact, no longer involved with a driven vehicle.

In cases where there are several people occupying a mode of transportation, for instance in situations where the user of device 10 is a passenger on a transportation vehicle, e.g., a bus, train or a vehicle, the non-driving user can be permitted to override the autonomous nature of the application. Thus, the application module 14 preferably includes a module to enable the user to momentarily (e.g., 15-minute intervals) override autonomous blocking of calls and messages before reverting back to the service suspension mode of operation. This may be done after the application module 14 issues an appropriate warning to the wireless device operator (and the user acknowledges the message) by querying the user whether to disable or revert back to suspension mode in response to a user acknowledgement of the query.

By way of example, a user interface on device 10 may receive user input to allow disabling (e.g., turning-off) of the service suspension application for a given interval (e.g., for a 15-minute interval). The interval may be repeatable, e.g., for up to an hour after which time the application module 14 reverts back to its autonomous service suspension mode of operation.

Once the application module 14 is loaded on a wireless mobile device 10 the ability to turn it off permanently is preferably disabled. As indicated above, newer smart devices may include an accelerometer chip that produces signals from which device velocity may be calculated directly. As such, a software module is preferably included that queries the accelerometer chip to ascertain the device's velocity from which to implement the above features (together with a location based service to determine if/when the wireless device is moving along a known street.)

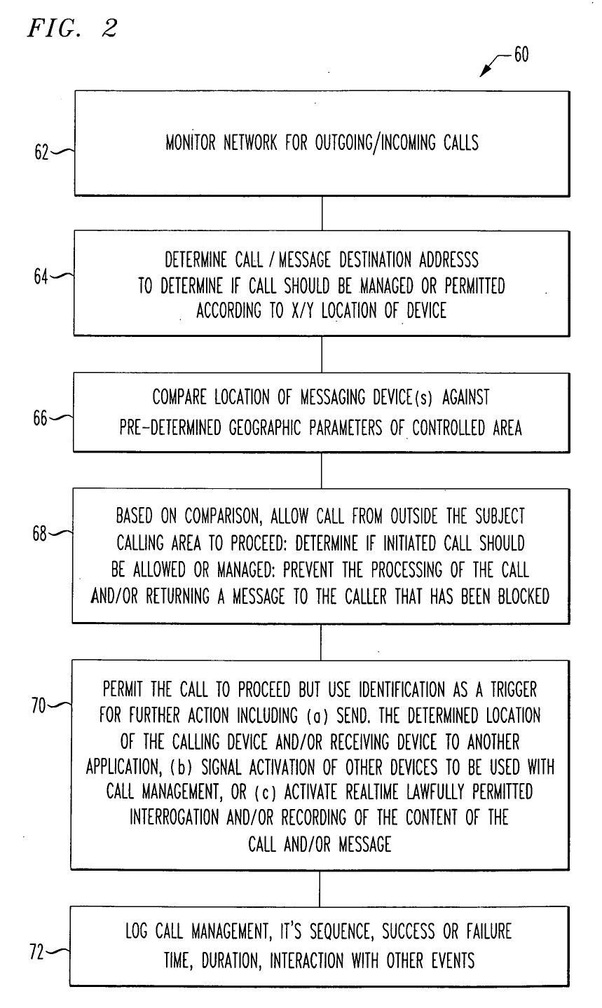

FIG. 2 shows a method 60 of providing automatic suspension of voice and/or short text message service for a mobile device in motion in accordance with another aspect of the invention.

In particular, as shown in FIG. 2, the method 60 comprises a step 62 of obtaining or detecting speed of the mobile device.

In step 64 it is determined whether or not the speed has reached a predetermined threshold.

In step 66 suspension of call and/or message service is automatically triggered in response to detection of its travel speed exceeding or reaching a given threshold. In given embodiments the suspension signal may be qualified by a location based services (LBS) determination of its position and/or travel on a known street.

In step 68 emergency call and/or message service is preferably retained even during suspension of service.

In step 70 an indication of service suspension is displayed on the mobile device.

In step 72 suspension is maintained for a predetermined period of time when the device momentarily stops.

In step 74 the user is optionally permitted to disable automatic suspension for a given period of time.

Advantageously, the method and system of the invention operates autonomously and is more likely to be effective in saving lives. The system and method hereof may be implemented by mobile device manufacturers and/or telecommunication service providers.

The invention is not limited by the illustrated embodiments as various modifications and adaptations may be made by those skilled in the art based on the above teachings.

While the invention has been described with reference to the exemplary embodiments thereof, those skilled in the art will be able to make various modifications to the described embodiments of the invention without departing from the true spirit and scope of the invention.

What is claimed is:

1. A method of automatically triggering suspension of a text messaging service on a wireless device while in a driven vehicle, comprising:
obtaining a speed of a wireless device capable of a text messaging service;
determining if said speed exceeds a predetermined threshold speed; and
automatically triggering suspension of said text messaging service if said speed exceeds said predetermined threshold speed.

2. The method of automatically triggering suspension of a text messaging service on a wireless device while in a driven vehicle according to claim 1, further comprising:
retaining emergency use of said text messaging service during said suspension of said text messaging service.

3. The method of automatically triggering suspension of a text messaging service on a wireless device while in a driven vehicle according to claim 1, further comprising:
displaying on said wireless device an indication of suspension of said text messaging service, when said text messaging service is suspended.

4. The method of automatically triggering suspension of a text messaging service on a wireless device while in a driven vehicle according to claim 1, further comprising:
maintaining suspension of said text messaging service for a predetermined period of time after said speed drops below said predetermined threshold speed.

5. The method of automatically triggering suspension of a text messaging service on a wireless device while in a driven vehicle according to claim 4, further comprising:
permitting a user of said wireless device to manually release said maintained suspension during said predetermined period of time.

6. The method of automatically triggering suspension of a text messaging service on a wireless device while in a driven vehicle according to claim 1, wherein:
said predetermined speed threshold is 5 mph.

7. The method of automatically triggering suspension of a text messaging service on a wireless device while in a driven vehicle according to claim 1, further comprising:
qualifying said automatically triggered suspension with an additional requirement that said wireless device be located on a known street.

8. The method of automatically triggering suspension of a text messaging service on a wireless device while in a driven vehicle according to claim 1, further comprising:
qualifying said automatically triggered suspension with an additional requirement that said wireless device be detected as traveling along a known street.

9. The method of automatically triggering suspension of a text messaging service on a wireless device while in a driven vehicle according to claim 1, further comprising:
presenting a manual override to temporarily disable an automatic suspension of said text messaging service for a given period of time.

10. A wireless device providing automatic suspension of a text messaging service when in a driven vehicle, comprising:
a speed detection module to obtain a speed of a wireless device capable of a text messaging service;
a threshold detector to determine if said obtained speed exceeds a predetermined threshold speed; and
a suspension triggering module to automatically trigger suspension of said text messaging service if said speed exceeds said predetermined threshold speed.

11. The wireless device providing automatic suspension of a text messaging service when in a driven vehicle according to claim 10, wherein:
emergency use of said text messaging service is permitted during. said automatic suspension of said text messaging service.

12. The wireless device providing automatic suspension of a text messaging service when in a driven vehicle according to claim 10, wherein:
said wireless device provides a display of an indication of suspension of said text messaging service, when said text messaging service has been suspended by said suspension triggering module.

13. The wireless device providing automatic suspension of a text messaging service when in a driven vehicle according to claim 10, wherein:
said suspension triggering module maintains suspension of said text messaging service for a predetermined period of time after said speed of said wireless device drops below said predetermined threshold speed.

14. The wireless device providing automatic suspension of a text messaging service when in a driven vehicle according to claim 10, wherein:
said suspension triggering module permits a user of said wireless device to manually release said maintained suspension during said predetermined period of time.

15. The wireless device providing automatic suspension of a text messaging service when in a driven vehicle according to claim 10, wherein:
said predetermined speed threshold is 5 mph.

16. The wireless device providing automatic suspension of a text messaging service when in a driven vehicle according to claim 10, wherein:
said suspension triggering module qualifies said automatically triggered suspension with an additional requirement that said wireless device be located on a known street.

17. The wireless device providing automatic suspension of a text messaging service when in a driven vehicle according to claim 10, wherein:
said suspension triggering module qualifies said automatically triggered suspension with an additional requirement that said wireless device be detected as traveling along a known street.

18. The wireless device providing automatic suspension of a text messaging service when in a driven vehicle according to claim 10, further comprising:
a manual override to temporarily disable an automatic suspension of said text messaging service for a given period of time.
